(19) United States
(12) Patent Application Publication
(10) Pub. No.: US 2018/0218389 A1
(43) Pub. Date: Aug. 2, 2018

(54) COLLECTION AND APPLICATION OF VISIBILITY STATISTICS IN ONLINE ADVERTISING

(71) Applicant: Google Inc., Mountain View, CA (US)

(72) Inventors: Troy L. Walker, Los Angeles, CA (US); Mehdi Sharifzadeh, Encino, CA (US); Lukas Rutishauser, Kirkland, WA (US); Thomas J. Murray IV, Culver City, CA (US); Sasank Mudunuri, San Francisco, CA (US)

(21) Appl. No.: 15/426,514

(22) Filed: Feb. 7, 2017

Related U.S. Application Data
(63) Continuation of application No. 12/571,078, filed on Sep. 30, 2009, now abandoned.
(60) Provisional application No. 61/242,606, filed on Sep. 15, 2009.

(51) Int. Cl. G06Q 30/02

(52) U.S. Cl. CPC G06Q 30/0242; G06Q 30/0277

(57) ABSTRACT

Methods, systems, and apparatus, including computer programs encoded on a computer storage medium, for collecting and applying visibility statistics in online advertising are disclosed. Ad block visibility data relating to initial visibility characteristics and subsequent visibility characteristics of ad blocks on webpages are collected from a sample of browser sessions and aggregated to provide a representative historical view of ad block visibility characteristics on those webpages. The collected visibility data are used to build a predictive model of ad block visibility characteristics for future sessions. Ad selection can be based on the predicted visibility characteristics for ad blocks on a webpage as rendered on a particular requesting client device. Ad targeting and pricing can be specified in terms of predicted visibility characteristics of ad blocks.

### CROSS-REFERENCE TO RELATED APPLICATIONS

This is a continuation of U.S. application Ser. No. 12/571,078, filed on Sep. 30, 2009, which claims priority to U.S. Provisional Application No. 61/242,606, filed on Sep. 15, 2009. The disclosures of the prior applications are considered part of and are incorporated by reference in the disclosure of this application.

### BACKGROUND

This specification relates to online advertising.

The internet provides access to a wide variety of resources, such as text, images, videos, audio files, and other multimedia content. These resources are often embedded or referenced in webpages that are served by various publishers on their websites. A user can request a webpage from a publisher using a web browser and gain access to the retrieved webpage along with the embedded or referenced resources in the web browser. A publisher can define ad slots, also known as “ad blocks,” at specific locations in a webpage for presenting advertisements. Advertisements can be dynamically selected and served in those ad slots according to various targeting criteria specified by advertisers when the webpage is retrieved and rendered in a web browser.

An advertising management system can be used to facilitate the value exchange between publishers and advertisers. Advertisers provide advertisements, specify targeting criteria for ad campaigns, and offer bids for the opportunities to have their advertisements presented on publishers' webpages. Publishers define advertisement slots in the primary content they publish on their webpages, for example, by referencing an ad request script provided by the advertising management system, at various locations on the webpages. When a user retrieves one of the webpages, the ad request script is executed and advertisements are retrieved and presented in the ad slots on the webpage.

A publishers can be paid according to the total number of impressions (e.g., presentation of ads) generated on the publisher's webpages. Conventionally, an impression is recorded when an advertisement is requested and retrieved by a browser. However, the impression count does not reflect whether the advertisement has actually been viewed by a user. Sometimes, a publisher may be paid according to the total number click-throughs (e.g., user selecting the presented ads) generated on the publisher's webpages. However, advertisers and publishers receive little guidance on whether a low click-through rate for an advertisement was due to a lack of user interest or a lack of actual visibility of the advertisement on the webpages.

### SUMMARY

This specification describes technologies relating to collection and application of visibility statistics for ad blocks on webpages.

Visibility characteristics of an ad block in a webpage include an initial visibility state of the ad block when the webpage is initially rendered in a browser window, subsequent visibility states of the ad block during a browser session, durations of the visible states, position of the ad block when visible, and so on. Visibility data indicative of the visibility characteristics of an ad block are collected from a large sample of browser sessions and aggregated to provide a representative historical view of the visibility characteristics of the ad block. The collected visibility data are used to build a predictive model of ad block visibility characteristics for future browser sessions.

When a webpage containing one or more ad blocks is downloaded by a user client device, client-specific ad block parameters are collected and used as input for the predictive model to predict visibility characteristics of the ad block. The predicted visibility characteristics include, for example, initial visibility state of the ad block, aggregated duration of visible states during the course of a browser session, position of the ad block when visible. Ad selection can be based at least in part on the predicted visibility characteristics (e.g., both initial visibility and visibility during the course of the browser session) for ad blocks on the webpage. Ad targeting criteria and ad slot pricing can be specified in terms of predicted visibility characteristics of ad blocks.

In general, one innovative aspect of the subject matter described in this specification can be embodied in methods that include the actions of receiving from a plurality of client devices display data for an ad block included in a webpage rendered in browser windows on the client devices, the display data indicating, for each client device: initial visibility data specifying an initial visibility state of the ad block included in the webpage rendered in the browser window on the client device, the initial visibility state indicating whether the ad block is visible in a viewport of the browser window as the webpage is initially rendered in the browser window; and generating a first predictive model that predicts the likelihood that the ad block is visible in a viewport of a browser window on a requesting client device when the webpage is initially rendered in the browser window on the requesting client device, the first predictive model being trained on the display data received from the plurality of client devices.

Other embodiments of this aspect include corresponding systems, apparatus, and computer programs, configured to perform the actions of the methods, encoded on computer storage devices.

These and other embodiments can each optionally include one or more of the following features.

In some implementations, the display data, for each client device, includes data specifying a plurality of client features, the client features including browser window dimensions and ad block positions; and the first predictive model predicts the likelihood that the ad block is visible in the viewport of the browser window on the requesting client device using the browser window dimensions of the requesting client device as input.

In some implementations, the actions further include: receiving an ad request for the ad block in the webpage, the ad request including browser window dimensions of a browser window on a particular requesting client device in which the webpage is to be rendered; using the first predictive model to predict a likelihood that the ad block of the ad request will be visible in a viewport of the browser window on the particular requesting client device when the webpage is initially rendered in the browser window; and selecting an advertisement to serve in response to the ad request, the selection being based in part on the likelihood that the ad block of the ad request will be visible in the viewport of the browser window on the particular requesting client device when the webpage is initially rendered in the browser window on the particular requesting client device.

In some implementations, for each of the plurality of client devices, the display data further indicates event data specifying events occurring in the client device and detected while the webpage is displayed in the browser window on the client device, the events being events that modify a current state of the viewport of the browser window; and the actions further include: for each detected event, determining a respective subsequent visibility state of the ad block, each subsequent visibility state indicating whether the ad block is visible in the viewport of the browser window in response to the occurrence of the detected event.

In some implementations, the actions further include: for each client device, determining an aggregated duration in which the ad block is visible in the viewport of the browser window, the aggregated duration being based on the visibility states that indicate the ad block is visible in the viewport of the browser window; generating a second predictive model that predicts the likelihood that the ad block is visible in a viewport of a browser window on a requesting client device for at least a threshold amount of time, the second predictive model being trained on the display data received from the plurality of client devices; using the second predictive model to predict the likelihood that the ad block will be visible in a viewport of a browser window on a particular requesting client device for at least the threshold amount of time; and selecting an advertisement for display in the ad block on the particular requesting client device, the selection being based in part on the likelihood that the ad block will be visible in the viewport of the browser window on the particular requesting client device for at least the threshold amount of time.

In some implementations, the events that modify the current state of the viewport include one or more of scroll, resize, focus, zoom, pan, and font resizing events.

In some implementations, the actions further include: calculating an expected aggregated duration in which the ad block is visible in a viewport of a browser window on a requesting client device, the expected aggregated duration being based on the visibility states of the ad block that indicate the ad block is visible in the viewports of the browser windows on the plurality of client devices; and selecting an advertisement for display in the ad block on a particular requesting client device, the selection being based on the expected aggregated duration for the ad block.

In some implementations, the display data, for each client device, includes data specifying a position of the ad block on the webpage and a relative size between the viewport and the webpage as initially rendered in the browser window on the client device; and the actions further include: for each client device, determining the initial visibility state of the ad block based on the position of the ad block on the webpage and the relative size of the viewport and the webpage as initially rendered in the browser window on the client device.

In some implementations, the actions further include: calculating an expected initial visibility state for the ad block based on the initial visibility states of the ad block for the plurality of client devices; and selecting an advertisement for display in the ad block on a particular requesting client device, the selection being based on the expected initial visibility state of the ad block.

In some implementations, the actions further include: providing a script to be embedded in the webpage; receiving display data from a particular requesting client device executing the script, the display data from the particular requesting client device indicating an initial visibility state of the ad block as rendered in a viewport of a browser window on the particular requesting client device; selecting an advertisement based on the initial visibility state of the ad block on the particular requesting client device; and transmitting the selected advertisement to the particular requesting client device for display in the ad block on the particular requesting client device.

In some implementations, the actions further include: providing an interface for advertisers to target advertising to the ad block based on the likelihood that the ad block is visible in a viewport of a browser on a requesting client device.

In some implementations, the webpage includes a plurality of ad blocks; the display data, for each client device, indicates a respective initial visibility state of each ad block on the webpage as displayed in the viewport of the browser window on the client device; and the actions further include: rating the plurality of ad blocks based at least in part on the initial visibility states of the ad blocks as indicated by the display data received from the plurality of client devices.

In some implementations, the actions further include: pricing ad placement in each of the plurality of ad blocks based on the rating of the ad block.

Particular embodiments of the subject matter described in this specification can be implemented so as to realize one or more of the following advantages.

By predicting ad block visibility characteristics (e.g., initial visibility state, aggregated duration of visible states, ad block position when visible, and so on), ad selection can be tailored to particular ad blocks to better suit an advertiser's advertising objectives. For example, ad blocks that are likely to be visible as initially rendered in a browser window (i.e., the above-the-fold ad blocks) can be identified and used to present advertisements that are aimed to generate prestige and brand awareness.

Premium prices can be charged for the above-the-fold or frequently visible ad blocks because these ad blocks are more likely to be effective in generating brand awareness and/or revenue for advertisers than other ad blocks on the webpage. Discounts can be applied to ad blocks that are less likely to generate actual viewing of the advertisements presented in those ad blocks. Therefore, advertisers get better value for their money and publishers get better compensation for well positioned ad blocks on their webpages.

Visibility characteristics for individual ad blocks on webpages can be used to rate the ad blocks and/or webpages. Ad block visibility characteristics can be correlated with ad block positions on webpages to provide guidance for publishers to produce highly effective ad placement locations on their webpages. Visibility characteristics for individual ad blocks on webpages can further be correlated with click-through rates for advertisements presented in those individual ad blocks. The resulting correlation can provide guidance for publishers and advertisers to diagnose the reasons for high click-through rates and low click-through rates of ads.

Collected visibility data can further be used to filter click-throughs on advertisements that are generated by automated bots. For example, if click-throughs for particular advertisements were recorded during browser sessions in which the advertisements were displayed in ad blocks that were not actually visible, these click-throughs are likely to be generated by automated bots and should be invalidated.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example online advertising environment.

FIG. 2 is a block diagram illustrating an example process for collecting visibility data from client devices and building a visibility predictive model for ad blocks.

FIG. 3 is a block diagram illustrating an example process for ad targeting based on predicted visibility characteristics of ad blocks.

FIG. 4 is a block diagram illustrating an example process for reporting visibility statistics to publishers and advertisers.

FIG. 5 is a flow diagram of an example process for targeting advertisement based on the predicted initial visibility characteristics of the ad block.

FIG. 6 is a flow diagram of an example process for targeting advertisement based on the predicted subsequent visibility characteristics of the ad block.

FIG. 7 is a block diagram of a programmable processing system.

Like reference numbers and designations in the various drawings indicate like elements.

### DETAILED DESCRIPTION

### I. Online Advertising Environment

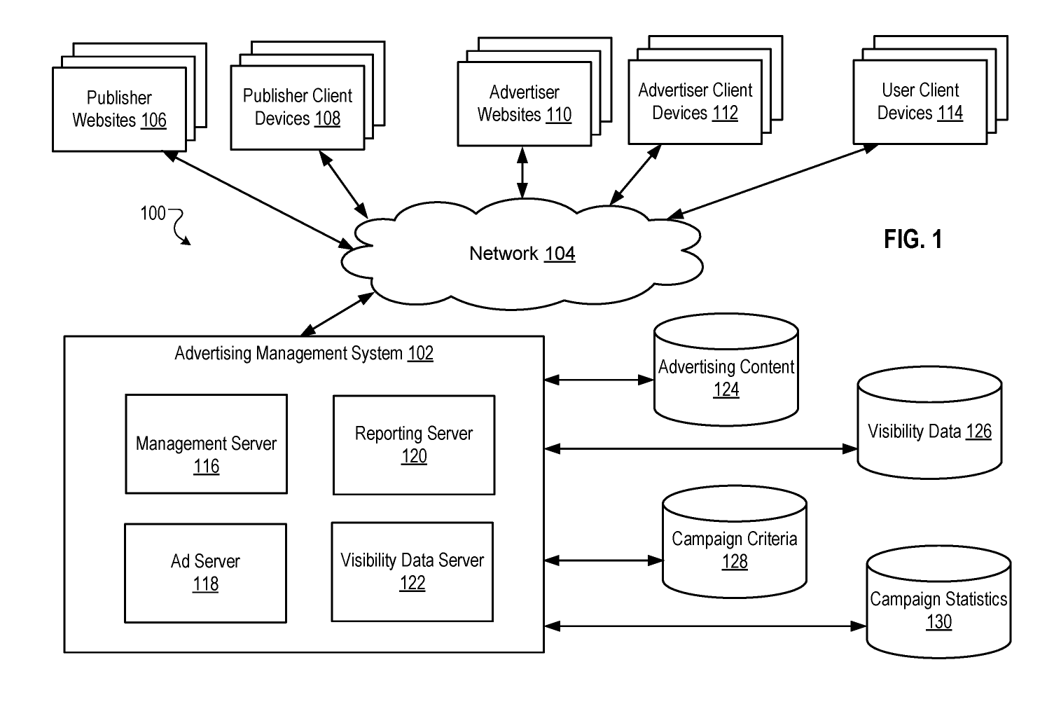

FIG. 1 is a block diagram of an example online advertising environment 100. The online advertising environment utilizes an advertising management system 102 to facilitate the sale and purchase of online advertising opportunities between publishers and advertisers.

The online advertising environment 100 includes a computer network 104, such as a local area network (LAN), wide area network (WAN), the internet, or a combination thereof, connecting publisher websites 106, publisher client devices 108, advertiser websites 110, advertiser client devices 112, user client devices 114, and the advertising management system 102. The advertising management system 102 further has access to an advertising content store 124, a visibility data store 126, a campaign criteria store 128, and a campaign statistics store 130.

Each publisher website 106 has one or more webpage resources associated with a domain name, and each publisher website 106 is hosted by one or more servers. An example website is a collection of webpages formatted in hypertext markup language (HTML) that can contain text, images, multimedia content, and programming elements, such as scripts. Each publisher website 106 is maintained by a publisher, e.g., an entity that manages and/or owns the website. For brevity, the term “publisher” will also be used to refer to a website 106 that is managed and/or owned by the publisher. Similarly, websites 110 are maintained by corresponding advertisers, and the term “advertiser” will also be used to refer to a website 110 that is managed and/or owned by an advertiser.

Publisher client devices 108, advertiser client devices 112, and user client devices 114 are electronic devices that are under the control of users and are capable of requesting and receiving data over the network 104. A client device typically includes a user application, such as a web browser, to facilitate the sending and receiving of data over the network 104, such as requesting a resource (e.g., webpage content) from a publisher 106 or advertiser 110, and other devices (e.g., the advertising management system 102) that are capable of sending and receiving data over the network 104.

The advertising management system 102 facilitates the sale and purchase of advertising opportunities between publishers 106 and advertisers 110. The advertising management system 102 includes components such as a management server 116, an ad server 118, a reporting server 120, and a visibility data server 122. Although described as individual servers, the management server 116, ad server 118, reporting server 120, and visibility data server 122 can be implemented in multiple servers in a server farm, and can share common hardware resources. Additionally, the functionality of the management server 116, ad server 118, reporting server 120, and visibility data server 122 can be implemented as software components that are not necessarily associated with a server entity. Other combinations of these and/or other components of the advertising management system 102 are possible.

The management server 116 provides user interfaces for advertisers (e.g., using advertiser client devices 112) to submit advertising content for ad campaigns and specify various targeting criteria for the advertising content in each advertising campaign. The advertising content is stored in the advertising content store 124 and the targeting criteria are stored in the campaign criteria store 128. The advertisers can also select particular publishers and/or ad slots and specify bids for those selected ad slots through the interface provided by the management server 116. Advertisers' bids and selections as well as other campaign related preferences are also stored in the campaign criteria store 128.

The management server 116 also provides an interface for publishers (e.g., using publisher client devices 108) to specify ad types and select advertisers and/or products that the publishers wish to advertise for. The management server 116 provides scripts or references to scripts to the publishers according to the specified ad types and the selected advertisers and/or products.

Each publisher 106 can insert scripts (e.g., those provided by the management server 116) into its webpages. When the webpages are downloaded to a user client device 114, the scripts are executed (either locally on the user client device 114 or remotely at a server of the advertising management system 102) to generate one or more ad requests to the advertising management system 102. The ad server 118 of the advertising management system 102 responds to the ad requests by sending advertisements to the requesting user client device 114 for insertion into the publisher's webpages rendered on the requesting user client device 114. The advertisements can include embedded links to landing pages (e.g., webpages on the advertisers' websites 110) that a user is directed to when the user clicks on the advertisements presented on the publisher's webpages.

The ad requests are optionally associated with user characteristics (e.g., user's age, gender, income, search history, language preferences, and so on) and advertising context (e.g., keywords associated with webpage content, location, local time of ad request, and so on). The ad server 118 can select advertisements from the advertising content store 124 for each ad request based on a match between an advertiser's campaign criteria in the campaign criteria store 128 and the user characteristics and advertising context associated with the ad request.

The advertisements provided, and optionally user responses (e.g., click-throughs, conversions, and so on) to the advertisements, are tracked by various tracking mechanisms (e.g., tracking cookies, pixel callbacks, etc.), sent back to the advertising management system 102, and stored in the campaign statistics store 130. The reporting server 120 provides user interfaces for advertisers and publishers to review reports on the campaign statistics in various formats. The reporting server 120 also presents charges and credits accumulated for each advertiser and publisher due to the impressions, click-throughs, and conversions that have been generated.

Conventionally, an impression is recorded when an advertisement is requested and retrieved by a browser. However, there is no reporting on whether the advertisement is actually viewed by a user. For example, as rendered in the browser viewport, the webpage may not display the ad block in which the advertisement is rendered, an impression is recorded for the advertisement even if the advertisement never becomes visible to a user during the browser session. Advertisers and publishers receive little guidance on whether a low click-through rate for an advertisement was due to a lack of user interest or a lack of actual visibility of the advertisement on rendered webpages.

In an online advertising environment (e.g., environment 100) according to the implementations described in this specification, the advertising management system 102 also includes the visibility data server 122. The visibility data server 122 collects visibility data of ad blocks on publisher webpages in response to the webpages being rendered in browsers on user client devices 114. The collect visibility data for each user client device 114 indicates visibility characteristics of ad blocks on a webpage rendered in a browser window on the user client device 114. The visibility characteristics of an ad block include, for example, whether particular ad blocks on the webpage are visible in a viewport of the browser window of the user client device 114 when the webpage is initially rendered in the browser window, and whether the particular ad blocks subsequently become visible or hidden during the browser session due to various events that affect the state of the browser window in which the webpage is rendered. The visibility data of ad blocks can be used to differentiate real impressions from recorded impressions that are never actually visible to a user. The visibility data can be used to adjust the charges to advertisers and the credits to publishers for the recorded impressions. The collected visibility data and the derived visibility characteristics of ad blocks can be stored in the visibility data store 126.

The visibility data server 122 also provides predictions of visibility characteristics for particular ad blocks on particular webpages (e.g., by utilizing predictive models of the ad blocks). For example, one or more predictive models can be used to generate a variety of predicted visibility characteristics. The predicted visibility characteristics include, for example, initial visibility state of a particular ad block, probability that the particular ad block is visible when initially rendered in a browser window, position of the ad block on the webpage when the ad block is visible, total duration in which the ad block is likely to be visible during a browser session, probability that the ad block is visible for more than a threshold duration during a browser session, and so on. The predictive models of ad blocks and the predicted visibility characteristics can also be stored in the visibility data store 126.

Given the availability of ad block visibility characteristics (predicted and/or actual) from the visibility data server 122, advertisers can specify campaign criteria that target particular visibility characteristics. The advertising management system 102 can select advertising content for insertion into a particular ad block on a webpage displayed on a user client device based on the visibility characteristics (either predicted and/or actual) of the ad block. Reporting of campaign statistics can be correlated with advertisement visibility statistics to provide better guidance to publishers and advertisers to improve the effectiveness of the advertisements and ad blocks.

### II. Collection, Prediction, and Application of Ad Block Visibility Statistics

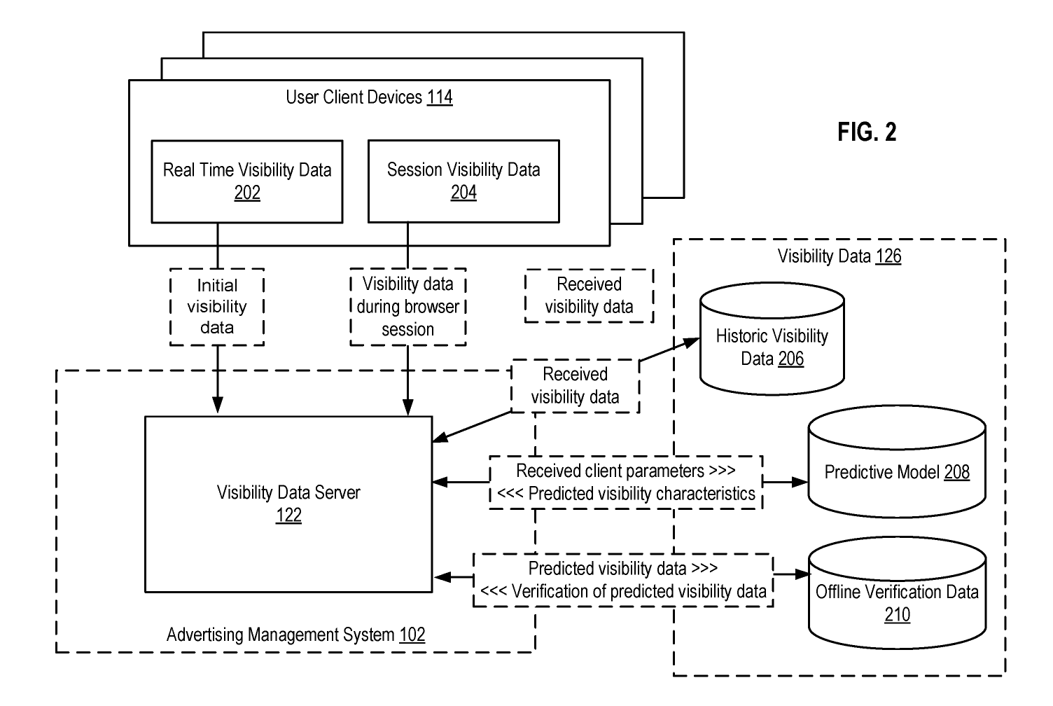

FIG. 2 is a block diagram illustrating an example process for collecting visibility data from client devices and building a visibility predictive model based on the collected visibility data.

### II.A. Collection of Visibility Statistics

Visibility data can be collected from multiple user client devices 114, both in real time when the webpage is being initially rendered in browser windows on the user client devices 114 and subsequently at the end of the current browser sessions. A browser session can be defined as a time period during which a webpage occupies a browser window of the browser. For example, a browser session can end when the user downloads a different webpage to display in the current browser window, when the user closes the current browser window, or when the user closes the browser, and so on.

For example, real time visibility data 202 for an ad block can be collected from the user client devices 114 in real time as the webpage is being rendered and before an ad request has been fulfilled on the user client devices 114. In order to facilitate the collection of real time visibility data, the publisher of the webpage can embed or reference a script in the webpage (e.g., as part of the ad request script supplied by the advertising management system 102). When the script is executed (e.g., locally on the user client devices 114 or remotely at the advertising management server 102), visibility data of the ad blocks on the webpage that are specific to the user client devices 114 are sent from the user client devices 114 to the visibility data server 122.

The collected visibility data include, for example, browser configurations, webpage configurations, ad block configurations, as well as other relevant client- or user-specific parameters. Browser configurations include, for example, browser window dimensions (e.g., height and width), browser version, device type, screen resolution, zoom level, font settings, and so on. Webpage configurations include, for example, default and actual webpage dimensions (widths and height), URL of the webpage, publisher identifier, webpage type (e.g., static or dynamically generated, text or multimedia, fixed format or adjustable format, and so on), fixed or adjustable font sizes specified for page content, number of ad blocks on the webpage, and so on. Ad block configurations include, for example, default and actual positions of the ad blocks on the webpage, sizes of the ad blocks, position of the ad block relative to other ad blocks on the webpage, and so on. Other parameters and information (e.g., user demographic information, keywords associated with the webpage, and so on) can be collected at the same time for ad targeting and data analysis purposes.

In some implementations, the real time visibility data 202 collected from the user client devices 114 are sent to the visibility data server 122, and the visibility data server 122 derives the initial visibility states of the ad blocks on the webpage using the collected visibility data 202. In some implementations, the user client devices 114 derives the initial visibility states and positions of the ad blocks using the browser, webpage, and ad block parameters, and sends the derived initial visibility states and ad block positions to the visibility data server 122 as part of the real time visibility data 202.

Various methods can be used to derive the initial visibility states of ad blocks. The initial visibility state of an ad block indicates whether the ad block is visible as initially rendered in a viewport of a browser window on a particular user client device 114. For example, given the width and height of the browser window's viewport, the width and height of the webpage as initially rendered according to the webpage configuration and browser configuration (e.g., viewport dimensions, resolution, zoom level, font sizes, and so on), the initial visible portion of the webpage can be derived. Given the initial positions of the ad blocks on the webpage (e.g., as specified in terms of pixel positions, or cell positions if placed in a table on the webpage, or an insertion point within a section of webpage's primary content, etc.), it can be derived whether each particular ad block falls within the initial visible portion of the webpage when the webpage is initially rendered in the viewport of the browser window on the particular user client device 114.

Depending on the number of parameters that are available and collected, sometimes the initial visibility state of an ad block can be determined to a certainty. However, in some scenarios, the design of the webpage is such that the initial visibility state cannot be predicted with certainty. In such scenarios, the initial visibility states of the ad blocks are estimated for the user client device 114 (e.g., based on a statistical model for the particular browser and/or webpage) using the available visibility data.

Ad blocks that are visible as initially rendered (i.e., “above-the-fold” ad blocks) are likely to produce actual viewing of the ads displayed in those ad blocks. Therefore, the above-the-fold ad blocks are considered more valuable and more prestigious to advertisers than ad blocks that are not initially visible (i.e., “below-the-fold” ad blocks). Advertisers are interested in knowing which ad blocks are above-the-fold ad blocks and select advertisements for those above-the-fold blocks such that the higher visibility and prestige of those ad blocks are better utilized.

In addition to the initial visibility states and/or initial positions of ad blocks on a webpage, advertisers are also interested in knowing the subsequent visibility states of the ad blocks when a user scrolls through the webpage to view the primary content of webpage. For example, as the user scrolls horizontally or vertically across the rendered webpage in the browser window, the above-the-fold ad blocks may exit the browser's viewport while other below-the-fold ad blocks may enter the viewport. For another example, when the user resizes the browser window, changes the screen resolution, zoom level of the browser window, or adjust the font size setting (e.g., by increasing or decreasing the default font size) of the browser window during a browser session, the webpage may be re-rendered according to the new browser configuration, and the ad blocks on the webpage may change their respective visibility states due to the re-rendering of the webpage.

For yet another example, when the user changes the focus state of the device user interface from the currently displayed browser window to a different browser window (e.g., by selecting a different browser tab), or to a different software application (e.g., by invoking a different software application), the browser window or the viewport of the browser window switches from being in a focused state to being in a blurred state. When the browser window or viewport switches from a focused state to a blurred state, even if the ad blocks are still rendered in the viewport of the browser window, it is likely that the user's attention has shifted away from the webpage and onto another webpage or application. Therefore, an ad block that is rendered in a “blurred” browser window may be considered an invisible ad block for the purpose of characterizing the visibility states of the ad block. In some implementations, an ad block may be considered visible as long as the blur event has not caused the entire viewport or browser window to become hidden on the user's screen.

Various events that occur during a browser session can affect the visibility states of the ad blocks on the webpage as currently rendered in the browser window, including zoom events, resize events, focus/blur events, and scroll events, font resizing events, for example. Other events may be relevant to determining the subsequent visibility states of ad blocks as well. For example, a blur event that causes a browser viewport to become hidden and a blur event that does not cause a browser viewport to become hidden may be registered differently for the purpose of determining the current visibility states of the ad blocks on the webpage.

The various events that occur during the browser session can be collected (e.g., as part of the session visibility data 204) at the time of the event occurrences or at the end of the browser session. An updated current visibility state and ad block position can be calculated for each ad block according to the previous visibility state and ad block position of the ad block as well as the changes in visibility state and/or ad block position caused by the event.

For example, if the current ad block position are specified in terms of pixels on the rendered webpage as (x, y), and a scroll event to the right by z pixels is registered, and if z is greater than x, then the ad block becomes at least partially invisible in the viewport of the browser window as a result of this scroll event. The visibility state of the ad block changes from being visible to being invisible. In some implementations, the visibility state of the ad block changes from being visible to being invisible only if the portion of the ad block that is partially invisible exceeds a threshold percentage, e.g., 10%.

For another example, when the user changes the zoom level of the webpage from 100 percent to 200 percent, the webpage is re-rendered in the browser window according to the newly specified zoom level. Depending on the design of the webpage, the positions of the ad blocks on the webpage may shift as a result of the re-rendering. The visibility state of each ad block can be re-determined as currently rendered. Some previously visible ad block may become invisible, and vice versa.

For each event that is registered in the browser, the current visibility state of each ad block after the occurrence of the event can be determined and recorded. A timer can be set and/or started for each ad block whenever the ad block enters a visible state, and the time can be stopped when the ad block enters an invisible state. Accordingly, the duration that the ad block is in the visible state can be tracked. Therefore, a visibility state change pattern and/or a total duration in which the ad block is visible can be obtained.

The subsequent visibility states of ad blocks or event data relevant for determining subsequent ad block visibility states can be collected during each browser session (e.g., as session visibility data 204), and submitted to the visibility data server 122 at the end of the browser session. The subsequent visibility data 204 are also stored in the visibility data store 126. The collection of subsequent visibility data of the ad blocks can be done on a sample of user client devices as in the case of real time collection of initial visibility data of ad blocks. The data submission of the initial visibility data and subsequent visibility data can be done together at the end of each browser session, or the data can be cached locally for a period of time before they are submitted to the visibility data server 122.

In some implementations, various sampling techniques can be applied to the collection of visibility statistics. For example, a random selection process can be built into the data collection script (e.g., as part of the ad request script), so only a certain percentage of randomly selected user client devices actually send in the visibility data to the visibility data server 122. In some implementations, only a certain percentage of randomly selected user client devices that fit particular selection criteria (e.g., having particular hardware or browser settings, etc.) actually send in the visibility data to the visibility data server 122. In some implementations, the sampling frequency can be adjusted based on server load or client device's processing power. Other sampling methods are possible.

### II.B Prediction of Visibility Statistics

The collected visibility data, including initial visibility data of ad blocks on webpages, and subsequent visibility data of ad blocks on the webpages during particular user browser sessions are stored as historic visibility data 206 in the visibility data store 126. The historic visibility data 206 are used to build predictive models of visibility characteristics for ad blocks, such as predictive model 208. Various statistical modeling methods can be used to build the predictive models, such as regression techniques and machine learning techniques applied to previously collected visibility data.

Different parameters or variables used in the predictive model 208 include, but are not limited to, browser configurations (e.g., browser type, device type, default and actual dimensions of the browser's viewport, default and actual screen resolution, default and actual zoom level, default and actual font settings, font increase or decrease levels, and so on), webpage configurations (e.g., URL of the webpage, default and actual dimensions of the webpage, fixed or adjustable font sizes specified for page content, default and actual positions of ad block on the webpage, number of ad blocks on the webpage, and so on), and ad block configurations (e.g., an identifier of the ad block, default and actual initial position of the ad block, default and actual dimensions of the ad block, and so on). Other parameters that are relevant to the predictive model include, for example, user or browser identifier, user demographic characteristics, time of access to the webpage, and so on.

The modeled visibility characteristics of ad blocks include, for example, the initial visibility states and initial ad block positions, the subsequent visibility states and subsequent ad block positions, total and average durations of the visible states of an ad block, the positions of the ad blocks while the ad blocks are visible, the number and identities of the ad blocks that are initially visible on a webpage, the number and identities of the ad blocks on a webpage that are visible for at least a threshold amount of time during a browser session, and so on).

The predictive model 208 can determine relationships between various relevant parameters and the visibility characteristics of the ad blocks using various statistical techniques. For example, regression techniques such as linear regression and multivariate regression models use historic visibility data 206 of ad blocks to derive mathematical relationships between relevant parameters and visibility characteristics of the ad blocks. Given one or more parameter values associated with a particular ad block, the model can be used to generate a prediction of the visibility states of the ad block, both as initially rendered in a viewport of a browser window, and as subsequently visible due to various user actions or events in the browser. The prediction can be stated in the form of a probability that the ad block is initially visible, a probability that the ad block will become visible subsequently during a browser session, a probability that the ad block is visible for more than a threshold amount of time during a browser session, and so on. Alternatively, the model predicts whether the ad block will be initially visible, will become visible during a browser session, will be visible for more than a threshold amount of time, and so on. The prediction can be associated with one or more confidence levels.

For another example, using machine learning techniques, the historic visibility data 206 for ad blocks on webpages are used as training data for the predictive model 208. When new visibility data are collected, the model 208 is refined according to the new data. In some cases, drastic change in visibility data for ad blocks on a webpage may indicate that the webpage structure has changed, and previously collected visibility data for the ad blocks on that webpage may need to be discarded to maintain validity of the predictive model based on the previously collected visibility data.

The predictive model can generate predictions of visibility characteristics for each ad block on a webpage. If no historic visibility data has been collected for a particular ad block on a particular webpage, the prediction can be based on the dimensions of the webpage and locations of the ad block on the webpage as specified by the publisher. Other variables (e.g., user-specific browser settings, device types, and so on) that tend to modify the locations of ad blocks can be estimated. Alternatively, on some publishers' websites, the page layout for certain categories of webpages are likely to be consistent over time even though the webpage content for each webpage changes frequently. For such webpages, the prediction of visibility characteristics for new or newly updated webpages can be based on the historic visibility statistics of other webpages of the same categories (e.g., pages that have similar URLs as the current webpage). For example, the New York Times constantly publishes new stories for different categories (e.g., business, sports, entertainment, etc.), and there are initially insufficient amounts of actual visibility data for webpages containing the new stories to provide accurate visibility predictions for ad blocks on the webpages. However, historic visibility data for other webpages containing older stories of the same categories can be used to generate predictions for the new webpages because the layouts of the webpages tend to be consistent over time and are relevant for the visibility predictions. A confidence level can be associated with each prediction depending on the availability of information as well as the weight of the parameter in the prediction of the visibility states according to the predictive model 208.

Other statistical modeling methods can be used to improve the accuracy of the predictions. For example, multiple modeling methods can be applied to the same set of visibility data, and the predictions from multiple models can be compared to reinforce the confidence level of the predictions. In some implementations, the predictive model 208 can be improved by offline verifications of the visibility state/ad block position predictions generated by the predictive model 208.

For example, given values of certain parameters, such as the URL, the browser width, the insertion location of the ad block on the webpage, a prediction of the ad block's initial visibility state is generated by the predictive model 208. The visibility data server 122 retrieves the webpage in a virtual or actual environment according to the given parameter values, and determines the actual initial visibility state of the ad block on the retrieved webpage. The actual initial visibility state is stored in the offline verification data store 210. The visibility data server compares the predicted initial visibility state and the actual visibility state of the ad block to determine whether the prediction is accurate. If the prediction is not accurate, the predictive model can be modified by the result of the offline verification.

The verification process can distill the relative importance of various parameters in generating accurate predictions of visibility states. In some cases, if the predictions based on certain parameters are not accurate, the predictive model 208 can discard predictions that are based on only those parameters. In some cases, if the predictions for certain webpage are consistently inaccurate, the predictive model 208 can discard predictions for those webpages. If predictions for certain webpages are consistently inaccurate, the inaccuracies might indicate that the webpage structure changes constantly and that the webpage is not suitable for such predictions. Offline verification process can also be used to generate historic visibility data for webpages that lack sufficient amount of visibility data received from user client devices, thereby enriching the predictive model 208 and expanding the coverage of the predictive model 208.

The predictive model 208 can be generated by the visibility data server 122 or by another system in communication with the visibility data server 122. The predictions can be generated in real time according to various input (e.g., a URL) sent from a user client device before the webpage is downloaded by the user client device. Alternatively, the predictions can be based on the input (e.g., URL, ad block location on the webpage, browser width, etc.) sent from a user client device at the time that a webpage is being rendered in the browser. A prediction can be made when the user client device requests an advertisement from the advertisement management server 102, such that ad targeting can be based on the prediction.

II.C Ad Targeting Based on Predicted Visibility Characteristics

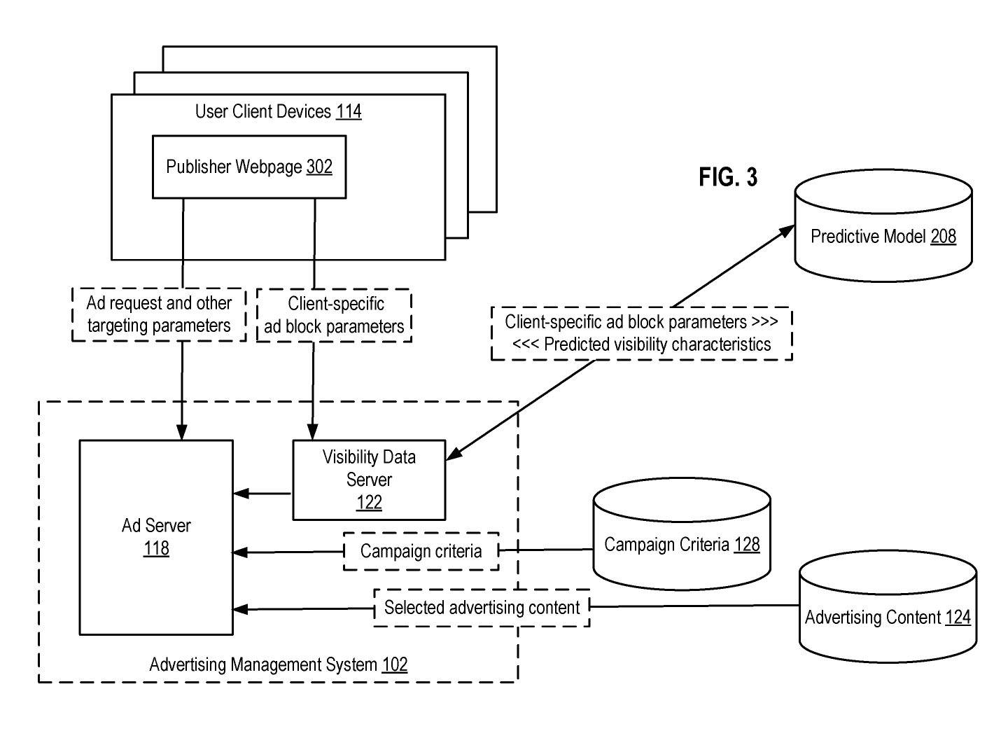

FIG. 3 is a block diagram illustrating an example process for ad targeting based on predicted visibility characteristics of ad blocks.

When a user client device 114 (the requesting device) downloads a webpage 302 that includes a publisher's ad requesting script, an ad request is sent to the ad server 118. The ad server 118 may also receive information relevant to ad targeting along with the ad request. For example, the targeting information may include user demographic characteristics, device type, time, location, content of the webpage, prior user behavior (e.g., prior click-throughs on the webpage), and so on. The ad server 118 may also receive visibility data from the requesting client device, such as the URL of the webpage, the dimensions of the webpage, the ad block parameters, along with the other targeting information.

The ad server 118 communicates with the visibility data server 122 to obtain predicted visibility characteristics of the ad blocks on the webpage 302. The visibility data server 122 provides client-specific parameters received from the requesting client device 114 to the predictive model 208. A prediction of visibility characteristics (e.g., initial visibility state, aggregated visible duration, ad block position, etc.) for the ad block is generated using the client-specific parameters and the data in the predictive model 208. The visibility data server 122 provides the predicted visibility characteristics for the ad blocks to the ad server 118.

The ad server 118 further obtains advertisers' targeting criteria from the campaign criteria data store 128, and corresponding advertising content from the advertising content store 124. Each advertiser can design various advertising campaigns, and specify advertising content for use in each of the advertising campaigns. Each ad campaign can have a specified purpose (promoting a particular brand and/or product) and runs for a particular period of time. Each ad campaign can also have a set of ad targeting criteria for selectively targeting the advertising content to particular user demographic characteristics, location, time, and so on.

The targeting criteria can also be specified based on ad block visibility characteristics. For example, the targeting criteria can state that all or at least a certain percentage of the advertising content in the ad campaign are to be displayed in ad blocks that are visible when a webpage is initially rendered in a viewport of a browser. Alternatively, the targeting criteria can specify that the advertising content is to be displayed in ad blocks that are not necessarily initially visible, but will become visible and remain visible for a threshold amount of time during a browser session. The advertisers can also specify the targeting criteria in terms of the likelihood that an ad block is initially visible or subsequently visible. For example, the targeting criteria can state that the advertising content is to be displayed in an ad block only if there is an 80% chance that it would be initially visible or remain visible for more than 50% of the time in a browser session. Alternatively, the advertiser can specify a targeting criterion in terms of the aggregated visibility characteristics of publishers' websites. For example, the targeting criteria can specify that the advertising content is to be displayed only on webpages from certain publishers whose webpages have at least a threshold percentage of above-the-fold ad blocks. The advertiser can also specify the price that it is willing to pay for an impression of a piece of advertising content according to the targeting criteria the advertiser has specified for the advertising content.

The ad server 118 selects advertising content for the ad block according to the match between the advertising criteria for the ad block and the predicted visibility characteristics of the ad block among other relevant characteristics for ad targeting. The selected advertising content is sent back to the requesting user client device 114, and displayed in the ad block according to the browser and webpage settings of the requesting user client device 114.

In some implementations, actual visibility data of the ad blocks collected during the browser session can be sent to the visibility data server 122. The actual visibility data can be used to modify the predictive model 208, and improve the visibility prediction for the ad block for future browser sessions.

### II.D Reporting of Visibility Statistics

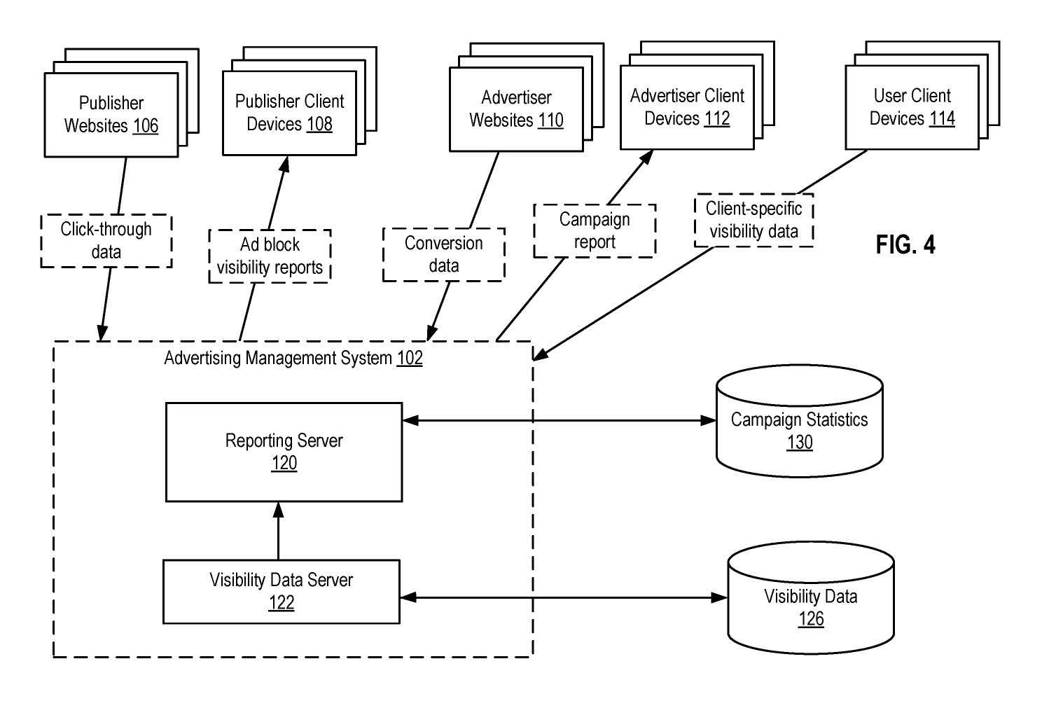

FIG. 4 is a block diagram illustrating an example process for reporting visibility statistics to publishers and advertisers.

When an advertisement is sent to a requesting user client device, the advertisement is displayed in an ad block on a webpage rendered in a browser window on the requesting user client device. The visibility states of the advertisement as rendered in the ad block can be collected during or at the end of the browser session. The actual visibility data that are collected include the initial visibility states of the advertisement, the subsequent visibility states of the advertisement, durations of the visible states, the positions of the advertisement on the webpage as rendered in the browser, the zoom level and size of the advertisement, the positions of the advertisement relative to other advertisements displayed on the webpage, and so on. Other parameters that are relevant in determining ad block and/or advertisement visibility states are also collected, such as URL of the webpage, time of the browser session, device type, browser's default and actual dimensions, viewport's default and actual dimensions, font sizes of page content, and so on.

When a multitude of user client devices request advertisements from the ad server, and the multitude of user client devices send actual visibility data to the visibility data server 122, the visibility data server 122 aggregates the visibility data for the advertisements and provides the aggregated visibility statistics to the reporting server 120. The reporting server 120 prepares ad visibility reports for analysis and review by advertisers and publishers.

In one example, given a URL, the visibility reports present the visibility characteristics of individual ad blocks on a webpage. The visibility characteristics of each ad block indicates whether the ad block is typically an above-the-fold ad block, whether the ad block becomes visible during a typical browser session, the total duration that the ad block is typically visible during a browser session, and the average duration that the ad block is visible each time it is visible, and so on.

The reporting server 120 can further rate the effectiveness of each ad block on the webpage according to its visibility characteristics. For example, an above-the-fold ad block can be rated as a better ad block than a below-the-fold ad block that subsequently becomes visible during a browser session. An above-the-fold ad block that is also visible for a long period of time can be rated as a better or more effective ad block than an above-the-fold ad block that is visible only for a short period of time. A below-the-fold ad block that is subsequently visible for a long period of time can be rated as a better ad block than a below-the-fold ad block that is rarely visible for any significant amount of time. Other rating criteria based on the visibility characteristics are possible. The rating and comparison of ad blocks can be made across multiple webpages.

In some implementations, the reporting server 120 in communication with the management server 116 (see FIG. 1) can provide the ad block ratings to advertisers through the management server 116, and the advertisers can specify an ad targeting criterion for an ad campaign according to the ratings. For example, an advertiser can specify that certain advertising content is to be displayed in ad blocks that have a rating above a certain threshold value.

In some implementations, the reporting server 120 can report the performance of publishers according to the actual or predicted visibility characteristics for ad blocks on the publisher's webpages. For example, the ratings of ad blocks on the publishers webpages can further be used to rate the publishers. If a publisher's webpage includes many highly rated ad blocks, the publisher receives a good rating as well. The reporting server 120 in communication with the management server 116 can provide the publisher ratings to advertisers through the management server 116, and the advertisers can specify an ad targeting criterion for an ad campaign according to the ratings of the publishers. An advertiser can select only publishers whose ratings are above a particular threshold value for displaying the advertiser's advertisements.

In some implementations, ad block visibility characteristics can also be correlated with positions or regions on a webpage, such that a “heat map” can be created indicating areas on the webpage that tend to produce highly rated ad blocks. The heat map provides guidance to advertisers for selecting ad blocks to display their advertisements, and also provide guidance to publishers to better design their webpages to produce more effective ad blocks.

In some implementations, when rating ad blocks, publishers, and/or positions on webpages, the ratings can be further categorized according to various filters such as device type, browser type, webpage length, primary content type, and so on. These categorized ratings can be presented to publishers and advertisers through a user interface provided by the reporting server 120, and provide further guidance for the publishers to produce more effective ad blocks, and for the advertisers to select more suitable ad blocks for their various advertising campaigns.

The visibility characteristics of an ad block can also be correlated with the click-through or conversion rate of the advertisements displayed in the ad block. Click-through data can be collected from publisher websites 106, and conversion data can be collected from advertiser websites 108. The click-through data and the conversion data can be stored along with the impression data in the campaign statistics store 130. The click-through rate and conversion rate of an advertisement are indicative of a combined effectiveness of the advertisement and the ad blocks used for presenting the advertisement. If all advertisements presented in an ad block consistently have high click-through or conversion rate, then that indicates a highly effective ad block position. In contrast, if an advertisement consistently has a low click-through or conversion rate even though it is displayed in a highly visible ad block, then it indicates that this advertisement is not an attractive or effective advertisement. The correlation between campaign statistics (e.g., click-through and conversion data of advertisements) and visibility statistics (e.g., actual visibility characteristics of the advertisements) helps the advertisers to better diagnose the real reasons behind effective advertising campaigns.

The reporting server 120 also manages the value exchange between advertisers and publishers. Through a user interface provided by the reporting server 120, a publisher can review an accounting of the advertisements displayed on its website, and get credited for the impressions, click-throughs, and conversions generated on its website. Similarly, an advertiser can review an accounting of the advertisements displayed for each of its advertising campaigns, and get charged for the impressions, click-throughs, and conversions generated for each of the advertiser's advertising campaigns.

The value exchange between publishers and advertisers can take into consideration of the actual visibility statistics of the ad blocks in which the advertisements are displayed. For example, in an advertiser's report, the charges to the advertiser can be based on the advertisements that were displayed in ad blocks that were in fact visible during a browser session. A premium can be charged for advertisements that were displayed in the highly rated ad blocks (e.g., above-the-fold ad blocks, or ad blocks that are visible for more than a threshold amount of time, and so on). A discount can be applied to advertisements that were displayed in ad blocks that have low visibility or were visible in a region that does not tend to capture user attention. Various types of price differentiation can be applied according to the different combinations of visibility characteristics of the ad blocks in which the advertisements were displayed. Similarly, a publisher's report presents the performance of all of the ad blocks on the publisher's webpages. If an ad block is rarely visible, that ad block generates little revenue for the publisher, and the publisher may consider removing that ad block from the webpage, or move the ad block to a better position.

### III. Example Processes for Collection, Prediction, and Application of Visibility Statistics

### III.A. Initial Visibility Statistics

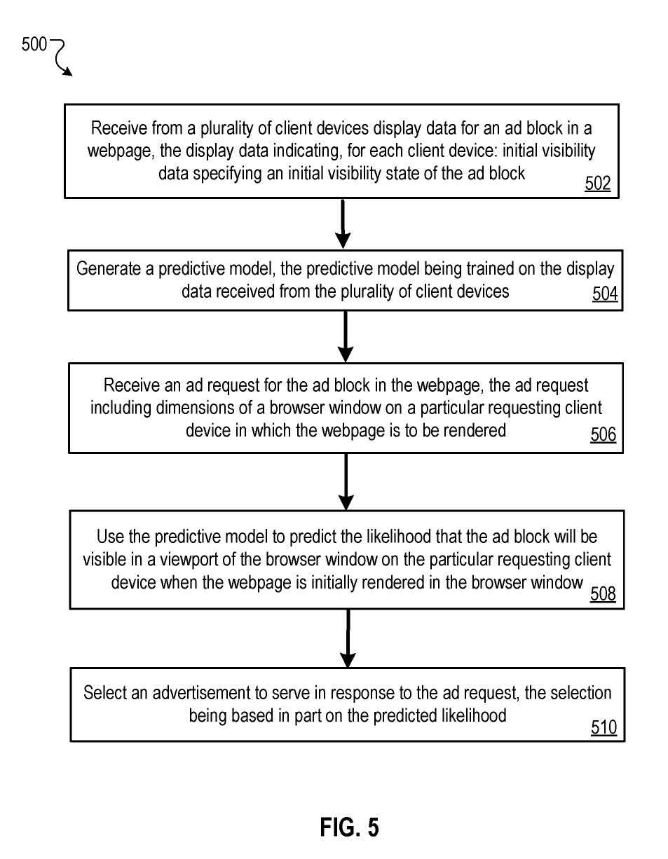

FIG. 5 is a flow diagram of an example process 500 for targeting advertisement based on the predicted initial visibility characteristics of the ad block. The process 500 collects visibility statistics, generates a visibility predictive model based on the collected visibility statistics, predicts visibility characteristics of an ad block using the visibility predictive model, and targets advertisements based on the predicted visibility characteristics.

The visibility data server 122 in conjunction with the ad server 118 of the advertising management system 102 can, for example, be used to perform the process 500. The visibility data server 122 receives from a plurality of client devices display data for an ad block included in a webpage rendered in browser windows on the plurality of client devices (502). The display data indicates for each of the plurality of client devices initial visibility data. The initial visibility data for each client device specifies an initial visibility state of the ad block included in the webpage as rendered in a browser window on the client device (e.g., the data can be used to derive the initial visibility state, or lists the initial visibility state). The initial visibility state of the ad block indicates whether the ad block is visible in a viewport of the browser window as the webpage is initially rendered in the browser window.

The display data constitutes at least a part of the visibility data collected from the plurality of client devices. The display data include information such as the dimensions of the webpage as initially rendered, the dimensions of the viewport of the browser window, the position of the ad block on the webpage, and so on. A viewport of the browser window represents the portion of the browser window that is visible on a display of the client device. In some implementations, the display data can be used to calculate the initial visibility state of the ad block. For example, the visibility data server can determine the initial visibility state of the ad block for each client device, based on a position of the ad block on the webpage as specified by the publisher, and a relative size of the viewport and the webpage as initially rendered on the client device. Alternatively, in some implementations, each client device can determine the initial visibility state of the ad block locally, and the display data also specifies the initial visibility state of the ad block. Other types of display data that can be used to determine the initial visibility states of the ad block are possible.

The visibility data server generates a predictive model (504). The predictive model predicts the likelihood that the ad block is visible in a viewport of a browser window on a requesting client device when the webpage is initially rendered in the browser window on the requesting client device. The predictive model is trained on the display data received from the plurality of client devices. The visibility data server utilizes the received display data from a multitude of client devices to build a statistical model of visibility characteristics in relation to various ad block parameters in the received display data and other data associated with the received display data.

The predictive model can be built according to one or more regression or machine learning techniques, or combinations thereof. The predictive model is refined as new display data is received from these and other client devices. The predictive model is capable of predicting the initial visibility states of an ad block given various parameters related to the webpage containing the ad block, the browser displaying the webpage, and the ad block itself. The predictive model can be refined by the visibility data server by generating predictions and performing off-line verifications of the predicted visibility states. If a prediction is not accurate according to the off-line verification process, the predictive model of that ad block is invalidated until more display data for the ad block becomes available. The predictive model may be rebuilt, if it is discovered that the historic display data received for an ad block is no longer valid because the webpage has changed its structure. The process for collecting visibility data and building a predictive model for visibility characteristics can continue in parallel with the process for generating predictions for ad blocks on particular requesting client devices for ad targeting purposes.

The ad server receives from a particular requesting client device an ad request for an ad block in a webpage rendered in a browser window of the requesting client device (506). The ad request includes client-specific parameters for the ad block, including dimensions of the browser window on the particular requesting client device in which the webpage is rendered or to be rendered. Other client-specific or ad block specific parameters can be included in the ad request as well. For example, client-specific browser configurations, webpage configurations, and ad block configurations that are relevant to predicting ad block visibility characteristics can be included in the ad request or retrieved from other sources.

The visibility data server utilizes the predictive model to predict the likelihood that the ad block will be visible in the viewport of the browser window on the particular requesting client device when the webpage is initially rendered in the browser window (508). The predictive model uses the browser window dimensions included the ad request as input. Other parameters sent along with the ad request or retrieved by the visibility data server according to the ad request can also be utilized as input to the predictive model in predicting the likelihood that the ad block will be visible in a viewport of the browser window as the webpage is initially rendered in the browser window. Other initial visibility characteristics, such as the initial position of the ad block and size of the ad block, can also be predicted using the predictive model.

The ad server selects an advertisement to serve in response to the request, the selection being based in part on the predicted likelihood (510). In some implementations, the advertising management server provides an interface for advertisers to target advertising to an ad block based on the likelihood that the ad block is visible in a viewport of a browser on the requesting client device. For example, an advertiser can specify a targeting criterion for certain advertisements such that those advertisements are only displayed in ad blocks that have at least a certain threshold probability of being visible when initially rendered.

In some implementations, the visibility data server calculates an expected initial visibility state for the ad block based on the display data of the ad block that have been received from the plurality of client devices. The expected initial visibility state indicates that the ad block is more likely to be visible than invisible on a webpage when the webpage is initially rendered in a viewport of a browser window on a requesting client device. The ad server selects an advertisement for display in the ad block based on the expected initial visibility state for the ad block.

In some implementations, the advertising management system (e.g., through the management server 116) provides a script to be embedded in the publisher's webpage. When the script is executed, the ad server receives visibility data from a particular requesting client device executing the script. The visibility data from the particular client device indicates (either explicitly or implicitly) an initial visibility state of the ad block as rendered on the particular requesting client device. The ad server selects advertising content based on the initial visibility state of the ad block on the particular requesting client device. The ad server sends the selected advertising content to the particular requesting client device for display in the ad block as rendered on the particular requesting client device.

In some implementations, the advertising management server receives data indicating the initial visibility state of each ad block on webpages displayed on each of the plurality of client devices. The advertising management server rates the plurality of ad blocks based on the data received from the plurality of client devices. The advertising management server prices ad placement in each of the plurality of ad blocks based on the rating of the ad block.

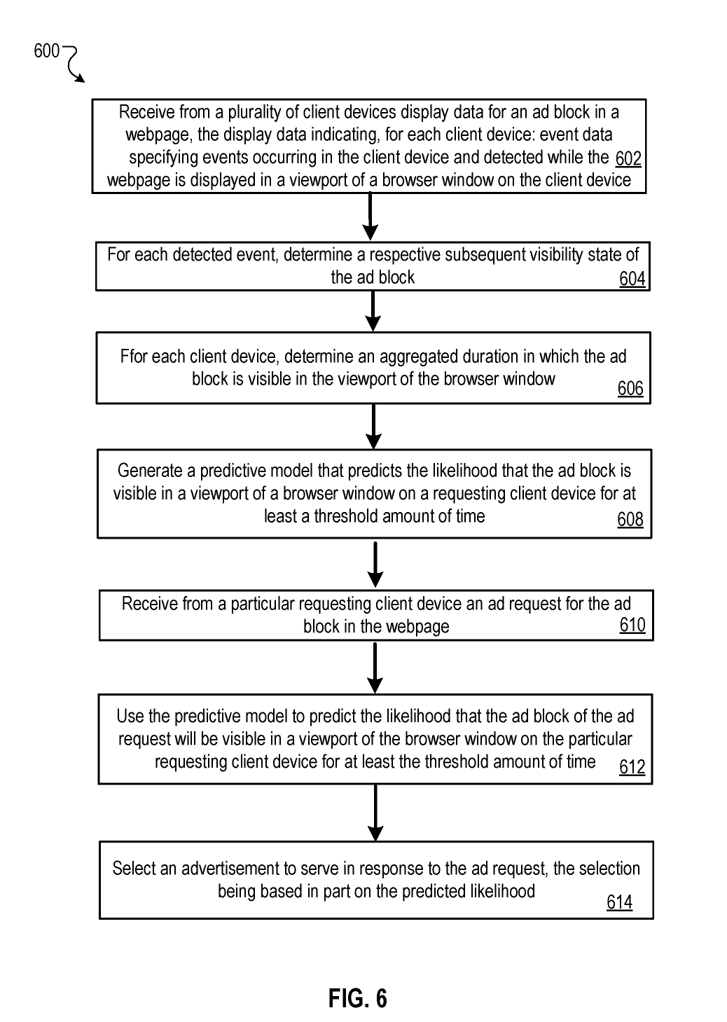

FIG. 6 is a flow diagram of an example process 600 for targeting advertisement based on the predicted subsequent visibility characteristics of the ad block. The process 600 collects visibility statistics, generates a visibility predictive model based on the collected visibility statistics, predicts subsequent visibility states of an ad block as rendered on a requesting client device, and targets advertisements based on the predicted subsequent visibility states of the ad block.

The process 600 can be performed by a visibility data server in conjunction with an ad server of an advertising management system. The visibility data server receives from a plurality of client devices display data for an ad block included in a webpage (602). For each of the plurality of client devices, the display data indicates event data specifying events occurring in the client device and detected while the webpage is displayed in the browser window on the client device, the events being events that modify a current state of a viewport of the browser window. The events that modify the current state of the viewport include one or more of scroll, resize, focus/blur, zoom/pan, and font resizing events. The display data including the events can be sent by a client device to the visibility data server at the end of each browser session. The display data sent at the end of each browser session can include both the initial visibility data and the subsequent visibility data for the ad block.

For each detected event, the visibility data server determines a respective subsequent visibility state of the ad block, and each subsequent visibility state indicates whether the ad block is visible in the viewport of the browser window in response to the occurrence of the detected event (604). In some implementations, the subsequent visibility states are derived locally at each client device and the display data explicitly specifies the subsequent visibility states. In some implementations, the display data does not explicitly list the subsequent visibility states and the display data is utilized by the visibility data server to derive the subsequent visibility states of the ad block.

For each client device, the visibility data server determines an aggregated duration in which the ad block is visible in the viewport of the browser window (606). The aggregated duration is based on the visibility states that indicate the ad block is visible in the viewport of the browser window. In some implementations, the aggregated duration is derived locally at each client device. In some implementations, the visibility data server derives the aggregated duration based on the received display data.

The visibility data server generates a predictive model that predicts the likelihood that the ad block is visible in a viewport of a browser window on a requesting client device for at least a threshold amount of time (608). The predictive model is trained on the display data received from the plurality of client devices. In some implementations, the predictive model also predicts other subsequent visibility characteristics of the ad block.

When an ad request for an ad block is received from a particular requesting client device (610), the visibility data server utilizes the predictive model to predict the likelihood that the ad block of the ad request will be visible in a viewport of a browser window on the particular requesting device for at least the threshold amount of time (612). In some implementations, other subsequent visibility characteristics of the ad block can also be predicted.

The ad server in communication with the visibility data server selects an advertisement to serve in response to the ad request, the selection being based in part on the likelihood that the ad block of the ad request will be visible in the viewport of the browser window on the particular requesting client device for at least the threshold amount of time (614).

In some implementations, the visibility data server calculates an expected aggregated duration for the ad block based on the visibility data of the ad block that have been received from the plurality of client devices. The ad server in communication with the visibility data server selects an advertisement for display in the ad block based on the expected aggregated duration for the ad block. Ad selection can also be based on a number of other targeting criteria, such as user demographics, time, location, other subsequent visibility characteristics, and initial visibility characteristics.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

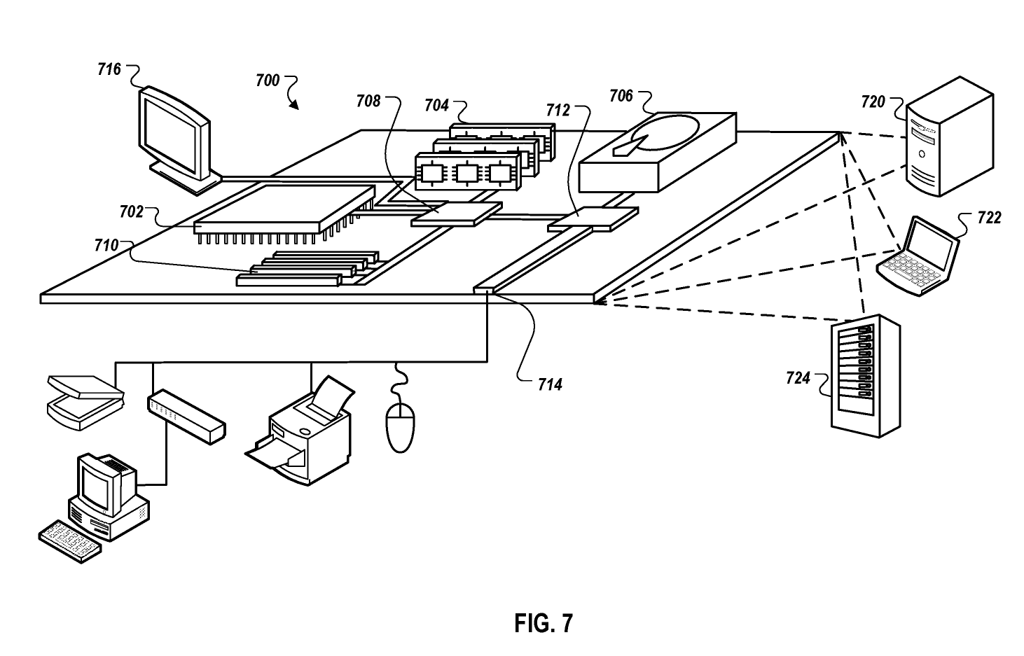

FIG. 7 is a block diagram of programmable processing system 700 that may be used to implement the systems and methods described in this document. System 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Programmable processing system 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the system 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple programmable processing systems 700 may be connected, with each device providing portions of the necessary operations (e.g., as a server bank, a group of blade servers, or a multi-processor system).

The memory 704 stores information within the programmable processing system 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the programmable processing system 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the programmable processing system 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The programmable processing system 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722 or a mobile device (not shown). Alternatively, components from programmable processing system 700 may be combined with other components in a mobile device (not shown). Each of such devices may contain one or more of programmable processing systems 1000, and an entire system may be made up of multiple programmable processing systems communicating with each other.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. (canceled)

2. A method comprising:
determining, by one or more servers and for a particular block of a resource that is rendered at a remote device, an initial visibility state specifying whether the particular block is visually presented within a viewport of the remote device when the resource is initially rendered at the remote device, including:
determining a portion of the resource that is initially visually presented within the viewport based on dimensions of the viewport and a zoom level setting used to initially display the resource at the remote device; and
determining the initial visibility state based on whether a location of the particular block is within the portion of the resource that is initially visually presented within the viewport;
collecting, by the one or more servers, visibility states of the particular block over a duration of a given presentation of the resource, including determining that the visibility state of the particular block of the resource changes between visible and not visible during the given presentation of the resource based on changes to display characteristics of the resource made by a user of the remote device causing the particular block of the resource to be located outside of the viewport for part of the given presentation; and
filtering, based on the collected visibility states, an automated bot interaction with content presented in the particular block, the filtering being performed based on a given interaction occurring when the visibility state of the particular block indicates that the particular block was not visible when the given interaction occurred.

3. The method of claim 2, wherein:
the display characteristics of the resource include browser window dimensions of a browser window on the remote device and a block position of the particular block; and
a first predictive model that indicates whether the particular block is visible in the viewport on the remote device using the browser window dimensions as input.

4. The method of claim 2, wherein:
the display characteristics of the resource further include event data specifying events occurring in the remote device and detected while the resource is displayed in the viewport, the events being events that modify a current state of the viewport; and the method further comprises:
for each detected event, determining a respective subsequent visibility state of the particular block, each subsequent visibility state indicating whether the particular block is visible in the viewport.

5. The method of claim 2, further comprising:
determining an aggregated duration in which the particular block is visible in the viewport, the aggregated duration being based on the visibility states that indicate the particular block is visible in the viewport;
generating a second predictive model that indicates whether the particular block is visible to a user of a browser on the remote device for at least a threshold amount of time, the second predictive model being trained on the display characteristics of the resource;
using the second predictive model to determine whether the particular block, as initially rendered in the resource, is visible to the user of the browser for at least the threshold amount of time; and
selecting content for display in the particular block on the remote device, the selection being based in part on whether the particular block is visible to the user of the browser for at least the threshold amount of time.

6. The method of claim 4, wherein the events that modify the current state of the viewport include one or more of scroll, resize, focus, zoom, pan, or font resizing events.

7. The method of claim 2, wherein:
the display characteristics of the resource include data specifying a position of the particular block on the resource and a relative size between the viewport and the resource as initially rendered in the viewport; and the method further comprises:
determining the initial visibility state of the particular block based on the position of the particular block on the resource and the relative size of the viewport and the resource as initially rendered in the viewport.

8. The method of claim 7, further comprising:
calculating an expected initial visibility state for the particular block based on the initial visibility states of the particular block; and
selecting content for display in the particular block on a particular remote device, the selection being based on the expected initial visibility state of the particular block.

9. The method of claim 2, further comprising:
providing a script to be embedded in the resource;
receiving display characteristics of the resource from the remote device executing the script, the display characteristics of the resource from the remote device indicating an initial visibility state of the particular block as rendered in a viewport;
selecting content based on the initial visibility state of the particular block on the remote device; and
transmitting the selected content to the remote device for display in the particular block on the remote device.

10. The method of claim 2, further comprising:
providing an interface for directing content to the particular block based on whether the particular block is visible to a user of a browser on the remote device.

11. The method of claim 2, wherein:
the resource includes a plurality of blocks;
the display characteristics of the resource indicate a respective initial visibility state of each block of the plurality of blocks as displayed in the viewport; and the method further comprises:
rating the plurality of blocks based at least in part on the initial visibility states of the plurality of blocks as indicated by the display characteristics of the resource received from the remote device.

12. A non-transitory computer-readable medium storing instructions, that when executed, cause one or more processors to perform operations including:
determining, by one or more servers and for a particular block of a resource that is rendered at a remote device, an initial visibility state specifying whether the particular block is visually presented within a viewport of the remote device when the resource is initially rendered at the remote device, including:
determining a portion of the resource that is initially visually presented within the viewport based on dimensions of the viewport and a zoom level setting used to initially display the resource at the remote device; and
determining the initial visibility state based on whether a location of the particular block is within the portion of the resource that is initially visually presented within the viewport;
collecting, by the one or more servers, visibility states of the particular block over a duration of a given presentation of the resource, including determining that the visibility state of the particular block of the resource changes between visible and invisible during the given presentation of the resource based on changes to display characteristics of the resource made by a user of the remote device causing the particular block of the resource to be located outside of the viewport for part of the given presentation; and
filtering, based on the collected visibility states, an automated bot interaction with content presented in the particular block, the filtering being performed based on a given interaction occurring when the visibility state of the particular block indicates that the particular block was not visible when the given interaction occurred.

13. The non-transitory computer-readable medium of claim 12, wherein:
the display characteristics of the resource include browser window dimensions of a browser window on the remote device and a block position of the particular block; and
a first predictive model that indicates whether the particular block is visible in the viewport on the remote device using the browser window dimensions as input.

14. The non-transitory computer-readable medium of claim 12, wherein:
the display characteristics of the resource further include event data specifying events occurring in the remote device and detected while the resource is displayed in the viewport, the events being events that modify a current state of the viewport; and the operations include:
for each detected event, determining a respective subsequent visibility state of the particular block, each subsequent visibility state indicating whether the particular block is visible in the viewport.

15. The non-transitory computer-readable medium of claim 12, the operations further comprising:
determining an aggregated duration in which the particular block is visible in the viewport, the aggregated duration being based on the visibility states that indicate the particular block is visible in the viewport;
generating a second predictive model that indicates whether the particular block is visible to a user of a browser on the remote device for at least a threshold amount of time, the second predictive model being trained on the display characteristics of the resource;
using the second predictive model to determine whether the particular block, as initially rendered in the resource, is visible to the user of the browser for at least the threshold amount of time; and
selecting content for display in the particular block on the remote device, the selection being based in part on whether the particular block is visible to the user of the browser for at least the threshold amount of time.

16. The non-transitory computer-readable medium of claim 14, wherein the events that modify the current state of the viewport include one or more of scroll, resize, focus, zoom, pan, or font resizing events.

17. A system comprising:
one or more processors; and
one or more memory elements including instructions that, when executed, cause the one or more processors to perform operations including:
determining, by one or more servers and for a particular block of a resource that is rendered at a remote device, an initial visibility state specifying whether the particular block is visually presented within a viewport of the remote device when the resource is initially rendered at the remote device, including:
determining a portion of the resource that is initially visually presented within the viewport based on dimensions of the viewport and a zoom level setting used to initially display the resource at the remote device; and
determining the initial visibility state based on whether a location of the particular block is within the portion of the resource that is initially visually presented within the viewport;
collecting, by the one or more servers, visibility states of the particular block over a duration of a given presentation of the resource, including determining that the visibility state of the particular block of the resource changes between visible and invisible during the given presentation of the resource based on changes to display characteristics of the resource made by a user of the remote device causing the particular block of the resource to be located outside of the viewport for part of the given presentation; and
filtering, based on the collected visibility states, an automated bot interaction with content presented in the particular block, the filtering being performed based on a given interaction occurring when the visibility state of the particular block indicates that the particular block was not visible when the given interaction occurred.

18. The system of claim 17, wherein:
the display characteristics of the resource include browser window dimensions of a browser window on the remote device and a block position of the particular block; and
a first predictive model that indicates whether the particular block is visible in the viewport on the remote device using the browser window dimensions as input.

19. The system of claim 17, wherein:
the display characteristics of the resource further include event data specifying events occurring in the remote device and detected while the resource is displayed in the viewport, the events being events that modify a current state of the viewport; and the operations further include:
for each detected event, determining a respective subsequent visibility state of the particular block, each subsequent visibility state indicating whether the particular block is visible in the viewport.

20. The system of claim 17, the operations further comprising:
determining an aggregated duration in which the particular block is visible in the viewport, the aggregated duration being based on the visibility states that indicate the particular block is visible in the viewport;
generating a second predictive model that indicates whether the particular block is visible to a user of a browser on the remote device for at least a threshold amount of time, the second predictive model being trained on the display characteristics of the resource;
using the second predictive model to determine whether the particular block, as initially rendered in the resource, is visible to the user of the browser for at least the threshold amount of time; and
selecting content for display in the particular block on the remote device, the selection being based in part on whether the particular block is visible to the user of the browser for at least the threshold amount of time.

21. The system of claim 19, wherein the events that modify the current state of the viewport include one or more of scroll, resize, focus, zoom, pan, or font resizing events.
